(19) United States
(12) Patent Application Publication
(10) Pub. No.: US 2019/0299526 A1
(43) Pub. Date: Oct. 3, 2019

(54) 3D NANOPRINTING DEVICE, METHOD, AND SYSTEMS

(71) Applicant: NanoPath, Inc., Leominster, MA (US)

(72) Inventor: Kevin Donahue, Harvard, MA (US)

(73) Assignee: NanoPath, Inc., Leominster, MA (US)

(21) Appl. No.: 16/373,213

(22) Filed: Apr. 2, 2019

Related U.S. Application Data
(60) Provisional application No. 62/652,183, filed on Apr. 3, 2018.

(51) Int. Cl. B29C 64/264; G02B 3/02; G02B 1/111; B33Y 10/00; B33Y 30/00; B29C 64/129; B29D 11/00; B29C 64/227; C09D 11/101; C09D 11/107

(52) U.S. Cl. CPC B29C 64/264; G02B 3/02; G02B 1/111; B33Y 10/00; B33Y 30/00; G02B 2207/101; B29D 11/0074; B29C 64/227; C09D 11/101; C09D 11/107; B29C 64/129

(57) ABSTRACT

This disclosure provides systems and methods for manufacturing three-dimensional structures. A system can include a reservoir configured to contain a volume of light-curative resin. The system can include a light source. The system can include a light guide configured to be positioned within the volume of light-curative resin in the reservoir and to receive light from the light source. The light guide can include a surface pattern that frustrates total internal reflection of the light within the light guide to provide emission of the light from the light guide to cure a portion of the light-curative resin corresponding to the surface pattern to form an object. The system can also include an actuator configured to move the light guide with respect to the reservoir.

### RELATED APPLICATIONS

This application claims priority to U.S. Provisional Patent App. No. 62/652,183, filed on Apr. 3, 2018 and entitled “3D NANOPRINTING DEVICE, METHOD, AND SYSTEMS,” which is incorporated by reference herein in its entirety.

### FIELD OF DISCLOSURE

Systems and methods are described for producing nano-scale 3D structures that can be deployed on a surface of an optical material to manipulate light.

### BACKGROUND

Light-curable liquid resins can be used to produce 3D objects using various techniques that can be referred to as additive manufacturing or three-dimensional (3D) printing. An example of 3D printing that deploys curable liquid resins is stereolithography (SLA). The SLA process can use a platen submerged in a light-curable resin. An object can be formed when the platen is incrementally raised and then exposed to curative electromagnetic radiation, such as a beam of ultraviolet light.

### SUMMARY

The systems and methods of this disclosure can use a light guide, rather than a directed light beam, to cure a light-curative resin, resulting in formation of a three-dimensional (3D) object. For example, the light guide can be treated to form a surface pattern that promotes a corresponding pattern of resin-curative light emission. The light guide can be submerged in a light-curative resin bath and moved in a 2D or 3D direction after each sequential activation of the light source to cure a portion of the resin. In this way, 3D structures can be built in sequential layers.

The systems and methods of this disclosure can be used to produce microscale or nanoscale 3D structures. In some implementations, these structures can be deployed on a surface of an optical material to manipulate light. The structures can also be used to capture or modify other forms of electromagnetic radiation to produce antennas and other devices. Embodiments of the present disclosure can provide the ability to produce nano-scale structures at a very high speed, over a wide area, and at a low cost. For example, performance and cost can be significantly improved using the systems and methods of this disclosure, as compared to other techniques such as micromachining and other means of depositing nanoscale features.

Implementations of this disclosure can make use of a physics phenomenon referred to herein as total internal reflection. In an example device, total internal reflection results when resin-curative light, most often UV light, is edge-injected into a patterned light guide. The pattern on the surface of the light guide can emit resin-curative light by frustrating total internal reflection of light within the light guide. This can occur because the pattern can be composed of “pixels” that have a geometry or material composition that causes entrapped light beams to exceed the critical angle needed to maintain total internal reflection, thereby escaping from the light guide. Thus, light can be emitted from the light guide in a pattern that corresponds to the surface pattern formed by the pixels on the light guide.

In many applications, a material such as air, which can have a much lower index of light refraction than a glass or plastic light guide, is the surrounding medium that enables total internal reflection (e.g., within a light guide). In some implementations, of this disclosure, the light-curative resin, which has a lower index of refraction than the submerged light guide, can be the medium that enables total internal reflection while also promoting object formation (e.g., by selective curing of the resin).

In some implementations, an example of a 3D printed item that can be produced by the current invention is a lens that can be coated with nano-scale features, such as optical pillars. In some implementations, the optical pillars or other features can be formed by selectively curing the resin on the surface of the lens using a light guide having a surface pattern as described herein. In some implementations, the optical pillars or other features can distort light in a manner that promotes optical effects such as magnification or anti-reflection when viewing an image through the lens.

At least one aspect of this disclosure is directed to a system for manufacturing three-dimensional structures. The system can include a reservoir configured to contain a volume of light-curative resin. The system can include a light source. The system can include a light guide configured to be positioned within the volume of light-curative resin in the reservoir and to receive light from the light source. The light guide can include a surface pattern that frustrates total internal reflection of the light within the light guide to provide emission of the light from the light guide to cure a portion of the light-curative resin corresponding to the surface pattern to form an object. The system can also include an actuator configured to move the light guide with respect to the reservoir.

In some implementations, the system can include a rail configured for attachment to the light guide. The actuator can be configured to slide the light guide along a length of the rail.

In some implementations, the actuator can be configured to move the light guide in at least two spatial dimensions.

In some implementations, the surface pattern of the light guide can be selected to cause the cured portion of the light-curative resin to form optical pillars on a substrate material. In some implementations, the substrate material can include a lens. In some implementations, the optical pillars can produce an optical effect including at least one of magnification or anti-reflection of an image viewed through the lens.

In some implementations, the system can include a second light guide configured to be positioned within the volume of light-curative resin in the reservoir. The second light guide can include a second surface pattern that frustrates total internal reflection of light within the second light guide. In some implementations, the surface pattern of the light guide is different from the second surface pattern of the second light guide. In some implementations, the system can include optical cladding configured to mechanically couple the light guide with the second light guide. In some implementations, the actuator can be configured to move the light guide, the optical cladding, and the second light guide together.

In some implementations, the surface pattern of the light guide can include a plurality of pixels each having a geometry configured to frustrate the total internal reflection of the light within the light guide. In some implementations, at least a subset of the plurality of pixels can have a diameter less than one micron.

Another aspect of this disclosure is directed to a method of manufacturing three-dimensional structures. The method can include providing a reservoir containing a volume of light-curative resin. The method can include positioning a light guide within the volume of light-curative resin in the reservoir. The light guide can include a surface pattern that frustrates total internal reflection of light within the light guide to provide emission of the light from the light guide. The method can include activating a light source to inject light into the light guide to cause the emission of the light from the light guide to cure a portion of the light-curative resin corresponding to the surface pattern to form an object.

In some implementations, the method can include deactivating the light source. In some implementations, the method can include moving the light guide within the volume of the light-curative resin in the reservoir using an actuator. In some implementations, the method can include reactivating the light source to cure a second portion of the light-curative resin. In some implementations, moving the light guide within the volume of the light-curative resin in the reservoir comprises moving the light guide in at least two spatial dimensions.

In some implementations, the method can include positioning a substrate material within the light-curative resin in the reservoir. In some implementations, the object can be adhered to a surface of the substrate material. In some implementations, the substrate material can include a lens.

In some implementations, the surface pattern of the light guide can include a plurality of pixels each having a geometry configured to frustrate the total internal reflection of the light within the light guide.

In some implementations, at least a subset of the plurality of pixels can have a diameter less than one micron.

In some implementations, the method can include positioning a second light guide within the volume of light-curative resin in the reservoir. The second light guide can include a second surface pattern that frustrates total internal reflection of light within the second light guide to provide emission of the light from the light guide. In some implementations, activating the light source can inject light into the second light guide to cause the emission of the light from the second light guide to cure a second portion of the light-curative resin corresponding to the second surface pattern to form the object.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a cross-sectional view of a system for manufacturing three-dimensional (3D) structures, according to an illustrative implementation.

FIG. 2 is a top view of a light guide that can be included in the system of FIG. 1, according to an illustrative implementation.

FIG. 3 is a side view of the system of FIG. 1 showing 3D structures that can be formed using the system, according to an illustrative implementation.

FIG. 4 is a side view of the system of FIG. 1 showing 3D structures coating the surface of a substrate material, according to an illustrative implementation.

FIG. 5 shows an example 3D part that can be produced using the system of FIG. 1, according to an illustrative implementation.

FIG. 6. is a side view of a system for manufacturing 3D structures, according to an illustrative implementation.

FIG. 7 shows an example 3D part that can be produced using the system of FIG. 6, according to an illustrative implementation.

FIG. 8 is a flowchart of an example method for manufacturing 3D structures, according to an illustrative implementation.

The details of various embodiments of the methods and systems are set forth in the accompanying drawings and the description below.

### DETAILED DESCRIPTION

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

The systems and methods of this disclosure can use a light guide, rather than a directed light beam, to cure a light-curative resin, resulting in formation of a three-dimensional (3D) object. For example, the light guide can be treated to form a surface pattern that promotes a corresponding pattern of resin-curative light emission. The light guide can be submerged in a light-curative resin bath and moved in a 2D or 3D direction after each sequential activation of the light source to cure a portion of the resin. In this way, 3D structures can be built in sequential layers.

The systems and methods of this disclosure can be used to produce microscale or nanoscale 3D structures. In some implementations, these structures can be deployed on a surface of an optical material to manipulate light. The structures can also be used to capture or modify other forms of electromagnetic radiation to produce antennas and other devices. Embodiments of the present disclosure can provide the ability to produce nano-scale structures at a very high speed, over a wide area, and at a low cost. For example, performance and cost can be significantly improved using the systems and methods of this disclosure, as compared to other techniques such as micromachining and other means of depositing nanoscale features.

Implementations of this disclosure can make use of a physics phenomenon referred to herein as total internal reflection. In an example device, total internal reflection results when resin-curative light, most often UV light, is edge-injected into a patterned light guide. The pattern on the surface of the light guide can emit resin-curative light by frustrating total internal reflection of light within the light guide. This can occur because the pattern can be composed of “pixels” that have a geometry or material composition that causes entrapped light beams to exceed the critical angle needed to maintain total internal reflection, thereby escaping from the light guide. Thus, light can be emitted from the light guide in a pattern that corresponds to the surface pattern formed by the pixels on the light guide.

In many applications, a material such as air, which can have a much lower index of light refraction than a glass or plastic light guide, is the surrounding medium that enables total internal reflection (within a light guide). In some implementations, of this disclosure, the light-curative resin, which has a lower index of refraction than the submerged light guide, can be the medium that enables total internal reflection while also promoting object formation (e.g., by selective curing of the resin).

In some implementations, an example of a 3D printed item that can be produced by the current invention is a lens that can be coated with nano-scale features, such as optical pillars. In some implementations, the optical pillars or other features can be formed by selectively curing the resin on the surface of the lens using a light guide having a surface pattern as described herein. In some implementations, the optical pillars or other features can distort light in a manner that promotes optical effects such as magnification or anti-reflection when viewing an image through the lens.

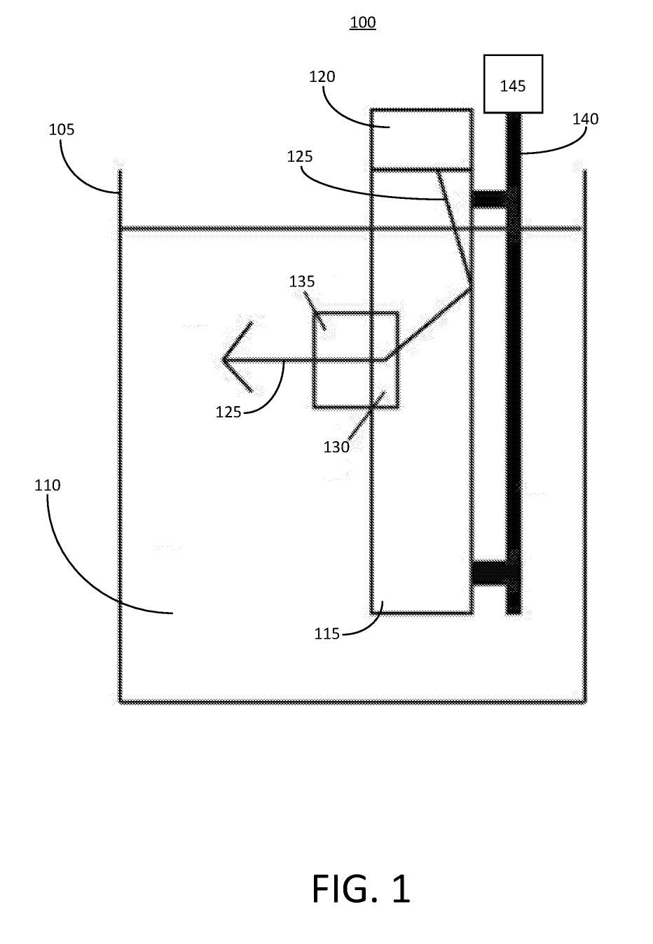

FIG. 1 is a cross-sectional view of a system 100 for manufacturing three-dimensional (3D) structures, according to an illustrative implementation. The system 100 includes a reservoir 105. The reservoir 105 can contain a volume of light-curative resin 110, which can be configured to solidify in response to selected electromagnetic radiation, such as ultraviolet (UV) light or other wavelengths of light. The system 100 also includes a light guide 115. At least a portion of the light guide 115 can be submerged or otherwise positioned within the volume of resin 110 inside the reservoir 105. In some implementations, the light guide 115 can be formed from a material having a high index of light refraction, such as polycarbonate having an index of refraction of about 1.55. In some implementations, the resin 110 can have a lower index of refraction. For example, the resin 110 can be a fluorinated UV-curable acrylate resin having an index of refraction of about 1.4.

The system 100 also includes a light source 120, which can be coupled with the light guide 115. For example, the light source 120 can be coupled with an edge of the light guide 115 and can be configured to introduce or inject light into the light guide 115. In some implementations, the light source 120 can be selected such that the light provided by the light source 120 is capable of curing the resin 110. The light source 120 can introduce light such as the light beam 125 into the light guide 115. The light beam 125 can reflect within the light guide 115 via total internal reflection, as described above. However, the light guide 115 can also include a surface pattern including one or more markings 130. The markings 130 can be configured to have a geometry, composition, or surface roughness that frustrates total internal reflection of the light inside the light guide 115, thereby allowing light beams to escape from the light guide 115 through the markings 130, as illustrated by the light beam 125. In some implementations, the marking 130 can be referred to as a pixel, and the surface of the light guide 115 can include any number of such pixels arranged in a predetermined pattern.

An object can form when light from the light source 120 contacts the resin 110 and cures or solidifies the portion of the resin 110 that it contacts. For example, as depicted in FIG. 1, an object 135 can form at or near a surface of the marking 130 through which the 125 escapes. In some implementations, the light guide 115 can be mounted to a rail 140. For example, the light guide 115 can be configured to slide along a length of the rail 140. The system 100 can also include an actuator 145 configured to actuate the light guide 115. For example, the actuator 145 can be configured to move the light guide 115 along a length of the rail 140. In some implementations, the actuator 145 can be configured to move the rail 140 itself. In some implementations, the actuator 145 can be or can include a motor such as a stepper motor. In some implementations, the actuator 145 may further include a control system configured to control the actuator 145. For example, the control system can include a processor configured to implement a set of instructions specifying how the actuator 145 is to drive at least one of the rail 140 and the light guide 115.

In some implementations, the system 100 can include additional components, such as additional rails or actuators similar to the rail 140 and the actuator 145. For example, each actuator 145 can be configured to move the light guide 115 in a respective spatial dimension along a respective rail 140. Thus, to achieve two or three-dimensional movement, the system 100 can include at least two instances of the rail 140 and the actuator 145, or at least three instances of the rail 140 and the actuator 145.

In some implementations, activating the light source 120 can cause one layer of the object 135 to form. Then, the light guide 115 can be moved using the actuator 145, and the light source 120 can be activated again to cure another portion of the resin 110 corresponding to a second layer of the object 135. This can be repeated until the object 135 has been fully formed.

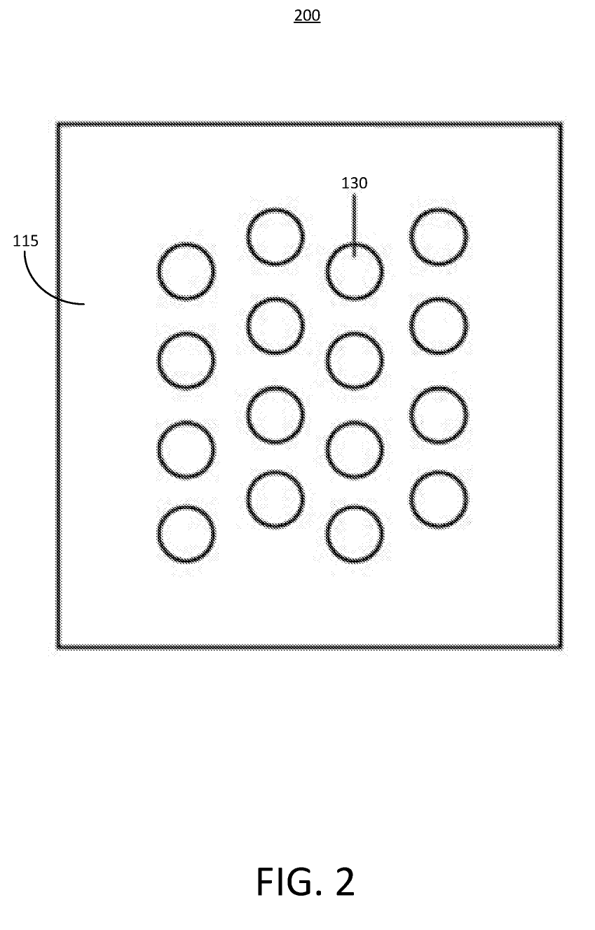

FIG. 2 is a top view 200 of a light guide 115 that can be included in the system 100 of FIG. 1, according to an illustrative implementation. As shown, the light guide 115 can have a flat (e.g., planar) surface that may have a square or rectangular shape. The surface of the light guide 115 can include a surface pattern formed from a set of markings 130. The markings 130 can be arranged in any pattern, and the pattern may include any number of markings 130. It should be understood that the pattern of the markings 130 depicted in FIG. 2 is illustrative only. For example, while the markings 130 of FIG. 2 are shown as having circular cross-sectional shapes, in some implementations each marking 130 may have a different shape than is depicted in FIG. 2. In some implementations, at least some of the markings 130 may have square, rectangular, elliptical, pentagonal, hexagonal, or octagonal cross-sectional areas. In some implementations, at least some of the markings 130 may have an irregular cross-sectional shape.

In some implementations, the markings 130 may have relatively small diameters. For example, the diameter of a marking 130 may be less than one micron in some implementations. Objects formed using the light guide 115 as described above in connection with FIG. 1 may have features that have sizes corresponding to the sizes of the marking 130. Thus, in some implementations, the light guide 115 can be used to form features having sub-micron sizes, which may be capable of sub-wavelength manipulation of light. For example, such features may be used to cause magnification of an image viewed through a surface on which the objects are formed, or to reduce reflection of ambient light.

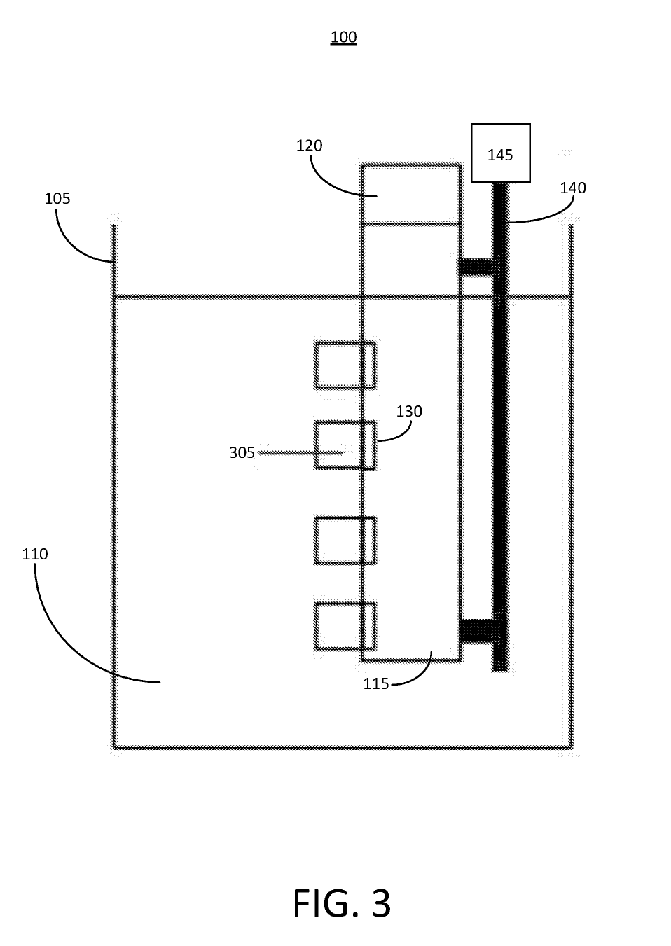

FIG. 3 is a side view of the system 100 of FIG. 1 showing 3D structures 305 that can be formed using the system 100, according to an illustrative implementation. For example, each of the 3D structures can correspond to an instance of the object 135 shown in FIG. 1. Thus, there may be a corresponding 3D structure 305 for each marking 130 that is present on the surface of the light guide 115. In some implementations, the structure 305 may adhere to the surface of the light guide 115. For example, curing of the first layer of the resin 110 can cause the cured portion of the resin 110 to adhere to the light guide 115 in the vicinity of the markings 130. Subsequent layers of the resin 110 can adhere to the previously cured portions of the resin 110 as well. Thus, the light guide 115 itself along with the structures 305 can form a complete 3D object. In some implementations, such an object may be a lens whose surface corresponds to the light guide 115. The 3D structures 305 can protrude from a surface of the lens and may serve as optical pillars that can cause magnification of an image viewed through the lens, or to reduce reflection of ambient light.

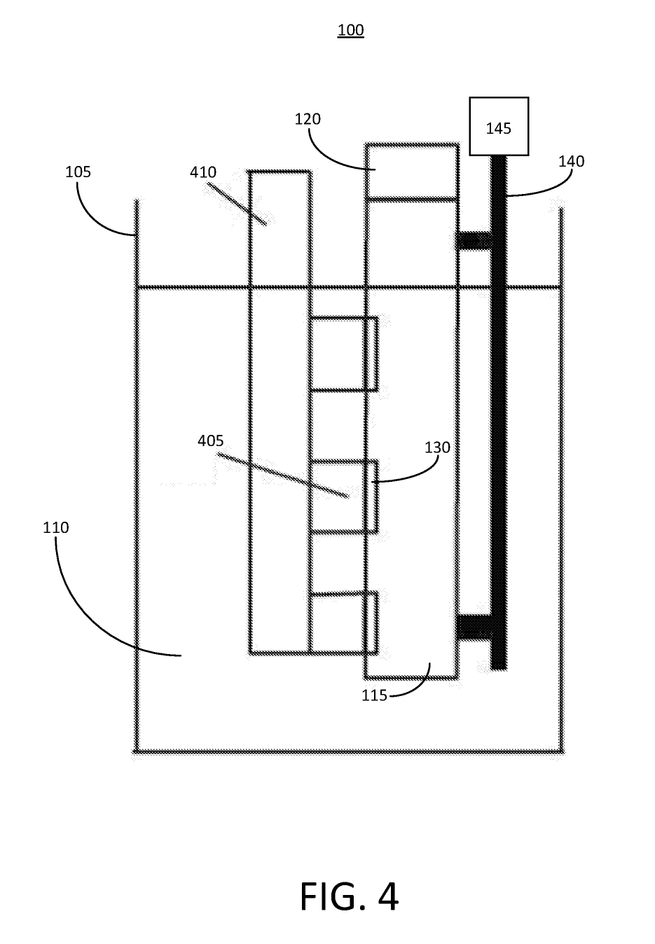

FIG. 4 is a side view of the system 100 of FIG. 1 showing 3D structures 405 coating the surface of a substrate material 410, according to an illustrative implementation. The substrate 410 can be submerged into the resin 110 within the reservoir 105. The system 100 can be used to form 3D structures 405 in a manner similar to that described above in connection with FIG. 3, for example. The 3D structures 405 can be similar to the 3D structures 305 of FIG. 3. For example, the 3D structures 405 can be optical pillars each corresponding to a respective one of the markings 130 of the light guide 115. In some implementations, as the 3D structures 405 can adhere to a surface of the substrate 410, and can be built up as a series of two or more successive layers on the surface of the substrate 410.

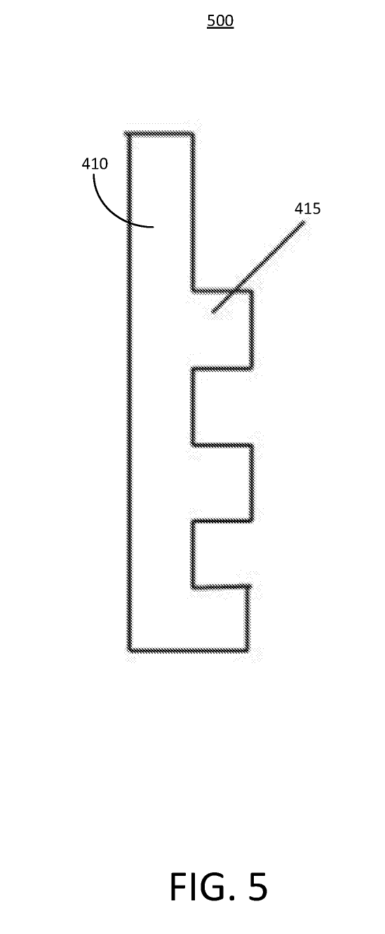

FIG. 5 shows an example 3D part 500 that can be produced using the system of FIG. 1, according to an illustrative implementation. For example, the part 500 can correspond to the substrate material 410 and the 3D structures 405 fabricated as shown in FIG. 4. In some implementations, the 3D part 500 can serve as a lens, and the 3D structures 415 can serve to manipulate light passing through the lens. For example, the 3D structures 415 can be optical pillars that help to provide magnification or anti-reflective properties to the lens. In some implementations, the 3D structures 405 and the substrate material 410 can have the same index of refraction, so that the 3D part 500 has an optically homogeneous composition. In some other implementations, the 3D structures 405 can have an index of refraction that differs from that of the substrate material 410.

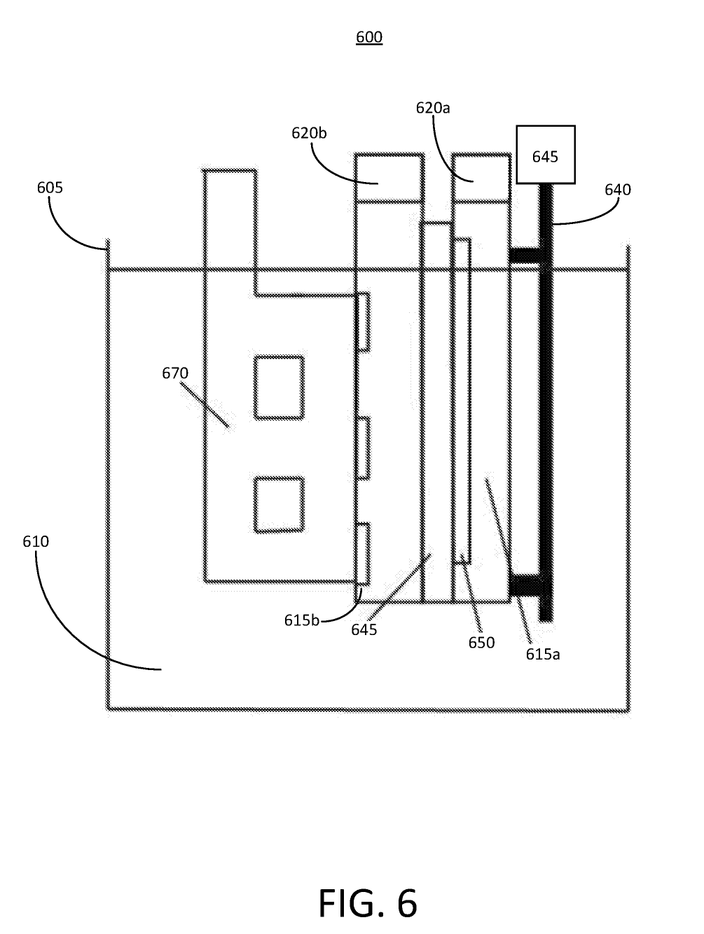

FIG. 6. is a side view of a system 600 for manufacturing 3D structures, according to an illustrative implementation. The system 600 includes many of the features of the system 100 shown in FIG. 1, and like reference numerals refer to like elements. For example, the system 600 can include a reservoir 605 that can contain a light-curative resin 610. A first light guide 615a can be at least partially submerged in the resin 610. A first light source 620a can be coupled with the first light guide 615a and configured to introduce light into the first light guide 615a. The system 600 can include a rail 640 to which the first light guide 615a is attached. An actuator 645 can be coupled with the rail 640 and configured to drive at least one of the rail 640 and the first light guide 615a.

The system 600 can also include a second light guide 615b. The second light guide 615b can have characteristics similar to those of the first light guide 615a. For example, the second light guide 615b can be formed from a material having a relatively high index of light refraction, such as polycarbonate (e.g., compared with an index of refraction of the resin 610). The second light guide 615b can also include a surface pattern including one or more markings that may be configured to have a geometry, composition, or surface roughness that frustrates total internal reflection of the light inside the second light guide 615b, thereby allowing light beams to escape from the second light guide 615b through the markings. In some implementations, the surface pattern of the second light guide 615b can be different from the surface pattern of the first light guide 615a.

A second light source 620b can be coupled with the second light guide 615b and configured to introduce light into the second light guide 615b. In some implementations, the first light source 620a and the second light source 620b can be configured to be activated independently of one another. The first light guide 615a and the second light guide 615b can be coupled with one another by optical cladding 655. In some implementations, the optical cladding 655 can have an index of refraction that is equal to that of either or both of the first light guide 615a and the second light guide 615b. In some implementations, at least a portion of at least one of the first light guide 615a and the second light guide 615b may be separated from the optical cladding 655 by a gap, such as the gap 650 shown in FIG. 6. In some implementations, because the first light guide 615a and the second light guide 615b are mechanically coupled via the optical cladding 655, the actuator 645 can drive both the first light guide 615a and the second light guide 615b together. In some other implementations, the system 600 can include a separate actuator to drive the second light guide 615b, so that the first light guide 615a and the second light guide 615b can be moved independently.

Together, first light guide 615a and the second light guide 615b can be used to fabricate a complex 3D part, such as the part 670 shown in FIG. 6. For example, because the surface patterns on each of the first light guide 615a and the second light guide 615b can be different, each of the first light guide 615a and the second light guide 615b can cause a different pattern of light to be emitted due to frustration of total internal reflection via the respective surface patterns. In addition, each of the first light source 620a and the second light source 620b can be configured to operate independently of one another. As a result, complex geometries can be formed in the 3D part 670 by selective curing of the resin 610 using the first light guide 615a and the second light guide 615b.

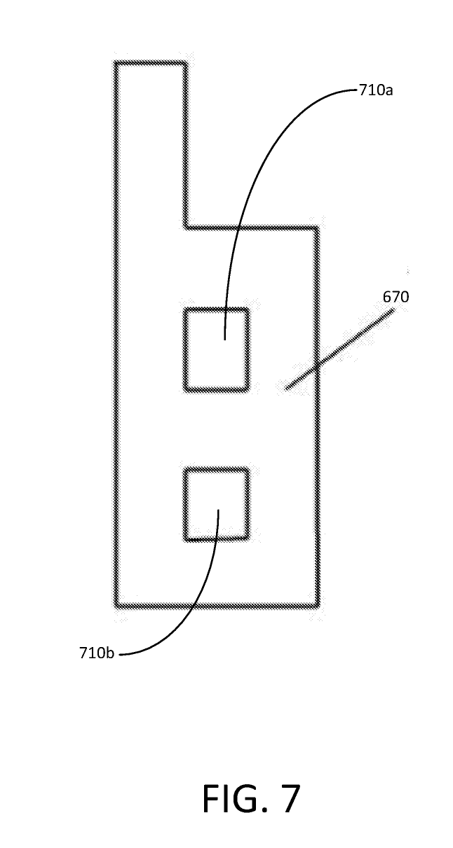

FIG. 7 shows the example 3D part 670 that can be produced using the system of FIG. 6, according to an illustrative implementation. The 3D part 670 can include complex features such that different layers of the 3D part 670 may have different cross-sectional shapes. Thus, the 3D part 670 can include features 710a, which in some implementations may correspond to voids or empty spaces within a central portion of the part 670. For example, such features can be fabricated by selecting the surface patterns of the first light guide 615a and the second light guide 615b, as well as the activation sequences of the first light source 620a and the second light source 620b, so achieve the 3D part 670 having the features 710a and 710b. It should be understood that the geometry of the 3D part 670 is illustrative only. In other implementations, a complex 3D part having a geometry different than that depicted in FIG. 7 can be fabricated using the two light guides in a system similar to the system 600 of FIG. 6 without departing from the scope of this disclosure.

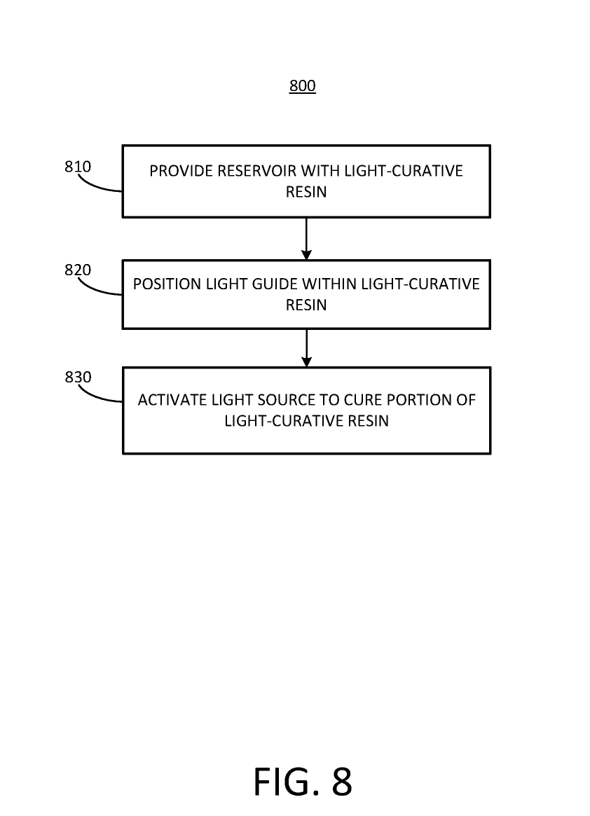

FIG. 8 is a flowchart of an example method 800 for manufacturing 3D structures, according to an illustrative implementation. The method 800 can include providing a reservoir containing a volume of light-curative resin (BLOCK 810). In some implementations, the resin can be a liquid material that is configured to solidify in response to selected electromagnetic radiation, such as UV light or other wavelengths of light. For example, the reservoir can be similar to the reservoir 105 and the resin can be similar to the resin 110 of FIG. 1.

The method 800 can include positioning a light guide within the volume of light-curative resin in the reservoir (BLOCK 820). In some implementations, the light guide can be formed from a material having a relatively high index of light refraction, such as polycarbonate having an index of refraction of about. In some implementations, the resin can have a lower index of refraction. In some implementations, the light guide can also include a surface pattern that frustrates total internal reflection of light within the light guide to provide emission of the light from the light guide. For example, the surface pattern can include one or more markings or “pixels” that are configured to have a geometry, composition, or surface roughness that frustrates total internal reflection of the light inside the light guide. As a result, light beams can escape from the light guide through the markings. In some implementations, the surface of the light guide can include any number of such markings or pixels arranged in a predetermined pattern. At least a subset of the plurality of pixels can have a diameter less than one micron.

The method 800 can include activating a light source to cure a portion of the light-curative resin (BLOCK 830). For example, the light source can be coupled to an edge of the light guide. Activating the light source can cause the light source to inject light into the light guide. Because the light guide includes the surface pattern as described above, injection of light into the light guide can result in the emission of some of the light from the light guide according to the surface pattern. Thus, the emission of light can cure a portion of the light-curative resin corresponding to the surface pattern to form a solid object.

In some implementations, the method 800 can also include deactivating the light source. Then the light guide can be moved within the volume of the light-curative resin in the reservoir using an actuator, and the light source can be reactivated to cure a second portion of the light-curative resin. In some implementations, moving the light guide within the volume of the light-curative resin in the reservoir can include moving the light guide in at least two spatial dimensions. In some implementations, the method 800 can include positioning a substrate material within the light-curative resin in the reservoir. For example, the solid object can be adhered to a surface of the substrate material as it forms via curing of the resin. In some implementations, the substrate material can include a lens.

In some implementations, the method 800 can include positioning a second light guide within the volume of light-curative resin in the reservoir. The second light guide can include a second surface pattern that frustrates total internal reflection of light within the second light guide to provide emission of the light from the light guide. For example, the second surface pattern can be different from the surface pattern of the first light guide.

In some implementations, activating the light source can inject light into the second light guide to cause the emission of the light from the second light guide to cure a second portion of the light-curative resin corresponding to the second surface pattern to form the object. In some other implementations, a second light source can be activated to inject light into the second light guide, independent from the light source that injects light into the first light guide. Due to the differing surface patterns, the light guide and the second light guide can be used to form a solid object having a complex geometry.

The embodiments of the inventive concepts disclosed herein have been described in detail with particular reference to preferred embodiments thereof, but it will be understood by those skilled in the art that variations and modifications can be effected within the spirit and scope of the inventive concepts.

Embodiments of the inventive concepts disclosed herein have been described with reference to drawings. The drawings illustrate certain details of specific embodiments that implement systems and methods of the present disclosure. However, describing the embodiments with drawings should not be construed as imposing any limitations that may be present in the drawings.

The foregoing description of embodiments has been presented for the purposes of illustration and description. It is not intended to be exhaustive or to limit the subject matter to the precise form disclosed, and modifications and variations are possible in light of the above teachings or may be acquired from practice of the subject matter disclosed herein. The embodiments were chosen and described in order to explain the principals of the disclosed subject matter and its practical application to enable one skilled in the art to utilize the disclosed subject matter in various embodiments with various modification as are suited to the particular use contemplated. Other substitutions, modifications, changes and omissions may be made in the design, operating conditions and arrangement of the embodiments without departing from the scope of the presently disclosed subject matter.

What is claimed is:

1. A system for manufacturing three-dimensional structures, the system comprising:
a reservoir configured to contain a volume of light-curative resin;
a light source;
a light guide configured to be positioned within the volume of light-curative resin in the reservoir and to receive light from the light source, the light guide comprising a surface pattern that frustrates total internal reflection of the light within the light guide to provide emission of the light from the light guide to cure a portion of the light-curative resin corresponding to the surface pattern to form an object; and
an actuator configured to move the light guide with respect to the reservoir.

2. The system of claim 1, further comprising a rail configured for attachment to the light guide, wherein the actuator is configured to slide the light guide along a length of the rail.

3. The system of claim 1, wherein the actuator is configured to move the light guide in at least two spatial dimensions.

4. The system of claim 1, wherein the surface pattern of the light guide is selected to cause the cured portion of the light-curative resin to form optical pillars on a substrate material.

5. The system of claim 4, wherein the substrate material comprises a lens.

6. The system of claim 5, wherein the optical pillars produce an optical effect comprising at least one of magnification or anti-reflection of an image viewed through the lens.

7. The system of claim 1, further comprising a second light guide configured to be positioned within the volume of light-curative resin in the reservoir, the second light guide comprising a second surface pattern that frustrates total internal reflection of light within the second light guide.

8. The system of claim 7, wherein the surface pattern of the light guide is different from the second surface pattern of the second light guide.

9. The system of claim 7, further comprising optical cladding configured to mechanically couple the light guide with the second light guide.

10. The system of claim 9, wherein the actuator is configured to move the light guide, the optical cladding, and the second light guide together.

11. The system of claim 1, wherein the surface pattern of the light guide comprises a plurality of pixels each having a geometry configured to frustrate the total internal reflection of the light within the light guide.

12. The system of claim 11, wherein at least a subset of the plurality of pixels have a diameter less than one micron.

13. A method of manufacturing three-dimensional structures, the method comprising:
providing a reservoir containing a volume of light-curative resin;
positioning a light guide within the volume of light-curative resin in the reservoir, the light guide comprising a surface pattern that frustrates total internal reflection of light within the light guide to provide emission of the light from the light guide; and
activating a light source to inject light into the light guide to cause the emission of the light from the light guide to cure a portion of the light-curative resin corresponding to the surface pattern to form an object.

14. The method of claim 13, further comprising:
deactivating the light source;
moving the light guide within the volume of the light-curative resin in the reservoir using an actuator; and
reactivating the light source to cure a second portion of the light-curative resin.

15. The method of claim 14, wherein moving the light guide within the volume of the light-curative resin in the reservoir comprises moving the light guide in at least two spatial dimensions.

16. The method of claim 13, further comprising positioning a substrate material within the light-curative resin in the reservoir, wherein the object is adhered to a surface of the substrate material.

17. The method of claim 16, wherein the substrate material comprises a lens.

18. The method of claim 13, wherein the surface pattern of the light guide comprises a plurality of pixels each having a geometry configured to frustrate the total internal reflection of the light within the light guide.

19. The method of claim 13, wherein at least a subset of the plurality of pixels have a diameter less than one micron.

20. The method of claim 13, further comprising:
positioning a second light guide within the volume of light-curative resin in the reservoir, the second light guide comprising a second surface pattern that frustrates total internal reflection of light within the second light guide to provide emission of the light from the light guide; and
wherein activating the light source injects light into the second light guide to cause the emission of the light from the second light guide to cure a second portion of the light-curative resin corresponding to the second surface pattern to form the object.
